(19) United States
(12) Patent Application Publication
(10) Pub. No.: US 2006/0046884 A1
(43) Pub. Date: Mar. 2, 2006

(54) Drive train

(76) Inventor: Alan Estergomy, Ridge, NY (US)

Correspondence Address: LILLIE LAW, LLC, 269 SOUTHPORT ST, RONKONKOMA, NY, 11779, US

(21) Appl. No.: 10/932,509

(22) Filed: Sep. 1, 2004

(51) Int. Cl. F16G 1/28

(52) U.S. Cl. 474/205

(57) ABSTRACT

A drive train comprising a plurality of drive wheels having an axis and for connecting to a bicycle frame, said wheel having a substantially enclosed channel about its periphery for housing a linkage skate, having an opening orientated radially outward; said channel and linkage skate cooperatively forming a clutching means; wherein said linkage skate comprises a body with connecting means on the fore and aft portion thereof; wherein at least one of said drive wheels also has means for connecting to a sprocket wheel; and a pedal assembly operatively connected to the frame operatively connected together via a cable system; wherein said cable system includes a first cable connecting the first pedal assembly to the connecting means of a first linkage skate, a second cable connecting the second pedal assembly to the connecting means of a second linkage skate, and a third cable connecting said skates via connecting means.

### BACKGROUND OF THE INVENTION

This invention relates to an apparatus which minimizes the amount of energy expended by an individual to propel a vehicle by, inter alia, increasing the efficiency of the drive train thereof. More particularly, by increasing the efficiency of a bicycle, tricycle, quadracycle, personal watercraft, and/or aircraft (hereafter bicycle) drive train.

Traditionally, for example, a bicycle pedal drive train would only capture the full power of a force applied to a two pedal system at two moments in time, specifically, one moment for each respective pedal. More specifically, the amount of power/energy available for a one pound force F applied to a pedal at a given distance of one foot D would only produce the sine wave for each respective pedal offset by a I80 degree shift. Moreover, the maximum power would only be achieved the instant the applied force is perpendicular to pedal on the power stroke. Hence, only a subset of the available energy is captured under the traditional bicycle drive train.

Hence, it would be beneficial therefore to provide a drive train for propelling a vehicle, inter alia, a bicycle that increases the efficiency.

### SUMMARY OF THE INVENTION

The purpose of the present invention is to capitalize on the amount of energy expended by an individual to propel a vehicle by, inter alia, increasing the efficiency of the drive train. Particularly, by increasing the efficiency of a bicycle drive train by employing maximum drive when a force is applied to the pedal.

The present invention provides for a drive train comprising a first and second drive wheel, each wheel having a center defining the axis thereof and for connecting to a bicycle frame, said wheel having a substantially enclosed channel about its periphery for housing a linkage skate, said channel having an opening orientated radially outward from said center; said channel and linkage skate cooperatively forming a clutching means; wherein said linkage skate comprises a body with connecting means on the fore and aft portion thereof; wherein at least one of said drive wheels also has means for connecting to a sprocket wheel/chain ring (hereafter sprocket wheel); and a pedal assembly operatively connected to the frame; each pedal operatively connected together via a cable system; wherein said cable system includes a first cable connecting the first pedal subassembly to the connecting means of a first linkage skate, a second cable connecting the second pedal subassembly to the connecting means of a second linkage skate, and a third cable connecting said skates via connecting means.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIGURE I is a side elevation view of the present invention;

FIG. 2A is a plan view of the present invention having optional momentum assistance spring;

FIG. 2B is a plan view of the present invention having optional second phase pulley and momentum assistance springs;

FIG. 3A is a side elevation view of a drive wheel;

FIG. 3B is a front elevation view of said drive wheel;

FIG. 3C is a close up view of the channel;

FIG. 3D is a close up view of the channel depicting clutching means;

FIG. 3E is a side elevation view of the linkage skate;

FIG. 3F is a section-plan view of the clutching means;

FIG. 3G is an isometric view of the linkage skate depicting alignment means, ratcheting means;

FIG. 3H is a side elevation view of an alternative embodiment of the drive wheel; and

FIG. 3I is a front elevation view of an alternative embodiment of the drive wheel.

### DETAILED DESCRIPTION OF THE INVENTION

The following descriptions of the preferred embodiments are presented to illustrate the present invention and are not to be construed to limit the claims in any manner whatsoever.

Referring now to the drawings wherein like reference numerals identify similar structural elements of the device set forth herein, is illustrated by Fig. I a drive train constructed in accordance with a preferred embodiment of the present invention and designated generally by reference numeral I0. The drive train of the present invention may be employed in a variety of applications including recumbent and standard bicycle, tricycle, quadracycle, personal watercraft, and/or aircraft (hereafter bicycle) drive trains.

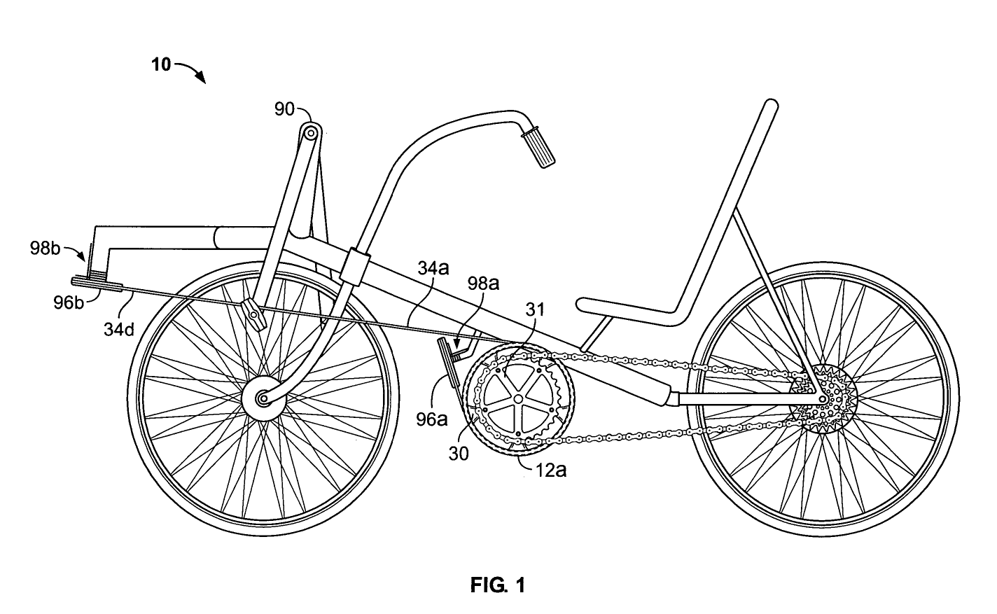

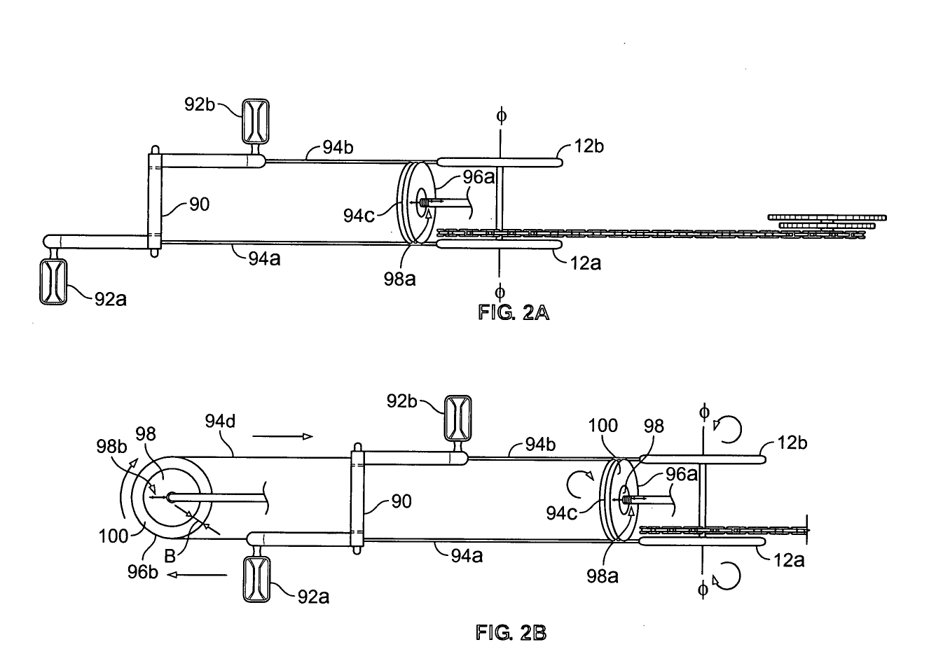

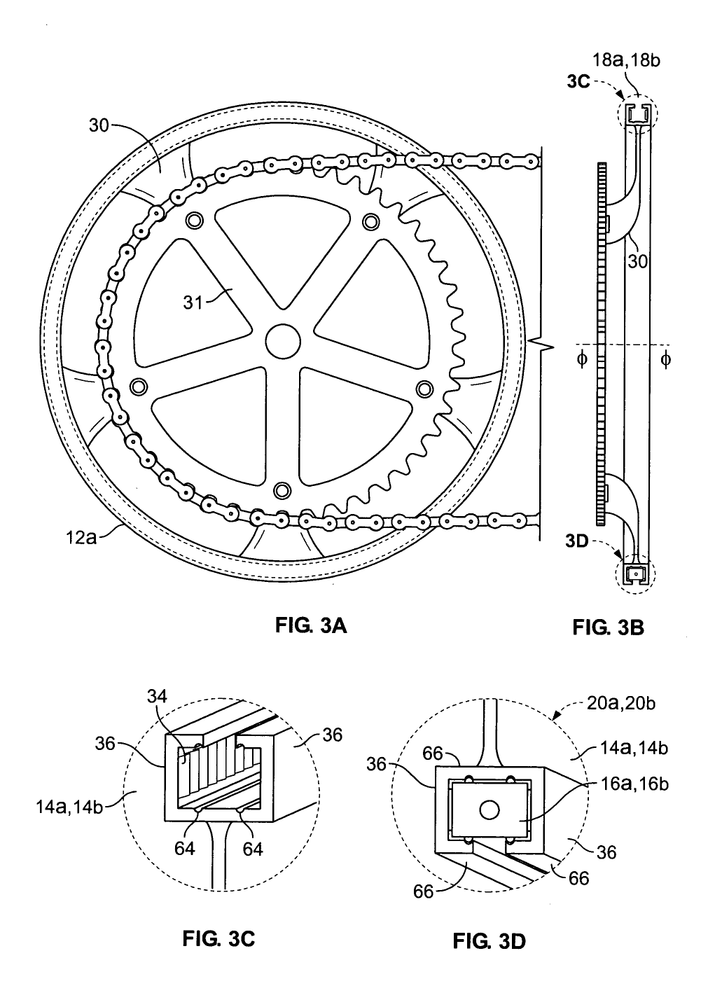

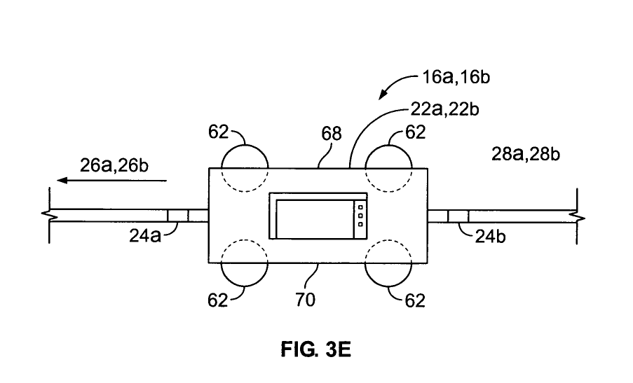

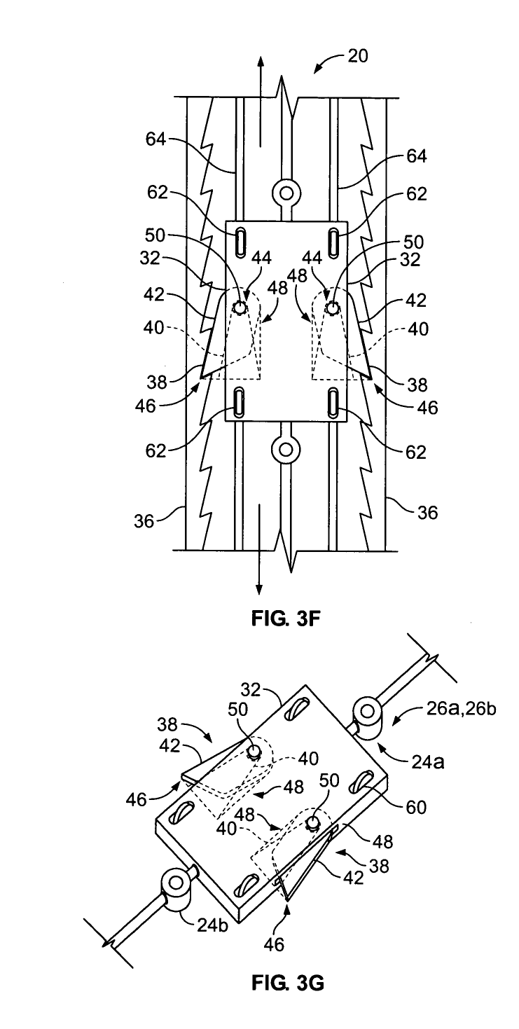

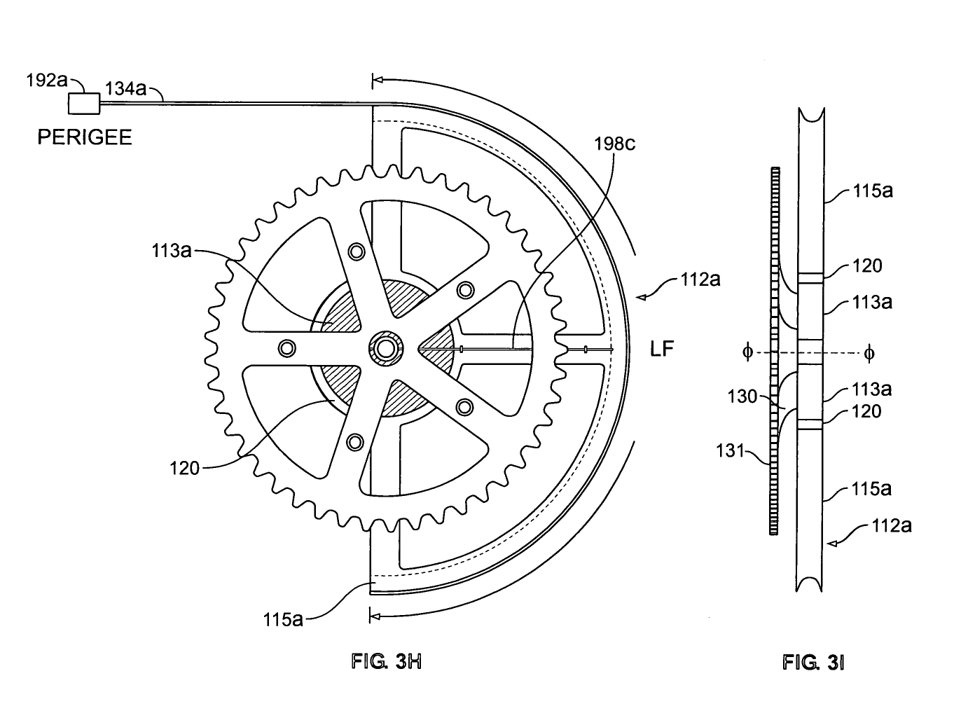

Referring to the FIGS. 2 through 3F, drive train I0 includes a first and second drive wheel I2a, I2b, each wheel I2a, I2b having a center defining the axis thereof and for connecting to a bicycle frame. Each of the drive wheels I2a, I2b having a substantially enclosed channel I4a, I4b about its periphery for housing a linkage skate I6a, I6b respectively. Each of the channels I4a, I4b having an opening I8a, I8b orientated radially outward from the respective center of the drive wheel I2a, I2b.

Each of the respective channel and linkage skate pairings, namely I4a, I6a and I4b, I6b respectively, cooperatively form a clutching means 20a, 20b best illustrated in FIG. 3F. The linkage skate I6a, I6b comprises a body 22a, 22b with connecting means 24a, 24b on the fore portions 26a, 26b and aft portions 28a, 28b thereof. The clutching means 20a, 20b comprises a ratcheting means 32 and an alignment means 60. The ratcheting means 32 comprises a series of teeth having a width 34, on the interior of a first pair of opposing walls 36 on said channel I4a, I4b, which cooperatively engage with a wing means 38 on each side of the body 22a, 22b best illustrated in FIGS. 3C and 3F. The wing means 38 include a spring 40, a wing 42 having a proximal and distal end 44, 46, and a recess 48 in said body 22a, 22b, said wing 42 being rotateably mounted to said body 22a, 22b via a pin 50 near the proximal end 44 wherein said spring 40 is mounted between said recess 48 and said distal end 46.

The alignment means 60 includes a translational means 80 which provides, inter alia, a friction reducing and/or wear reduction characteristic. In a preferred embodiment, the alignment means 60 further includes a rolling means 62 with a groove 64 for said rolling means 62 to reference. Wherein the rolling means 62 includes ball bearings mounted within the body 22a, 22b that run within a groove 64 on the interior of a second pair of walls 66. Although in a preferred embodiment there are four bearings on the top 68 and bottom 70 of the body 22a, 22b, in an alternative embodiment, only three bearings are incorporated on the bottom 70 of the body 22a, 22b, however, a third groove 64 would be needed for the third bearing. This three bearing embodiment would primarily reduce the number of parts of the bicycle drive train, in addition to reducing the overall mass thereof.

Moreover, another alternative embodiment (not shown) is where the alignment means 60 is on the same pair of walls as the ratcheting means 32. For example, the alignment means 60 and the ratcheting means 32 may both be on the interior of the first pair of walls 36. However, when this embodiment is employed, the width of the teeth 34 is limited so as to permit the inclusion of one or more grooves 64, and/or to at least permit the rolling means 62 to cooperatively function.

Furthermore, in still yet another embodiment (not shown), alignment means 60 may be on both the interior of the first pair of walls 36 and on the interior of the second pair of walls 66.

It is envisioned in additional embodiments that alignment means 60 may incorporate grooves 64 on the linkage skate I6, and rolling means 62 on the interior of walls 36, and/or 66 or any combination thereof.

In a preferred embodiment, at least one of the drive wheels I2a, I2b also has means for connecting 30 to a sprocket wheel 3I. For example, FIG. 2 depicts a typical setup for a bicycle drive train to the extent that the embodiment has only one front sprocket wheel 3I which is cooperatively connected to drive wheel I2a, further illustrated in FIGS. 3A and 3B. However, an alternative embodiment might include a plurality of front sprockets 3Ia, 3Ib etc, cooperatively connected to a drive wheel I2a (not shown). For example, a second front sprocket 3Ib might have a different diameter and/or quantity of teeth from the first 3Ia providing different gear ratios selectably useful for the varying slopes in terrain, and (i) the second sprocket 3Ib can also be mounted on the same drive wheel I2a as the first front sprocket 3Ia; and/or, (ii) the second front sprocket 3Ib might be mounted on the second drive wheel I2b but would need to contain the same quantity of teeth as the first sprocket 3Ia on the first drive I2a wheel if both drive wheels I2a, I2b are connected to the same road wheel (e.g., road wheel is the wheel/tire that contacts the ground (not shown)). For example, on a bicycle where both drive wheels I2a, I2b are connected to the rear road wheel, or in an all-wheel-drive version of the bicycle where both the front and rear road wheels have about the same diameter rim size (this would be necessary so as to match linear velocity and acceleration generated from the angular velocity and acceleration of the respective drive wheels and sprockets) (not shown). In a preferred embodiment, the sprocket connection means 30 between the drive wheel I2a and the sprocket wheel 3I includes inter alia, casting, fasteners, forging, molding, welding, and other conventional technologies.

Further included in the preferred embodiment is a pedal assembly 90 operatively connected to the frame of the vehicle. Moreover, wherein each pedal subassembly 90a, 90b is operatively connected together via a cable system 94. The cable system 94 includes a first cable 94a connecting the first pedal subassembly 90a to the connecting means 24b of a first linkage skate I6a, a second cable 94b connecting the second pedal subassembly 90b to the connecting means 24b of a second linkage skate I6b, and a third cable 94c connecting said skates I6a, I6b via connecting means 24a. Since both the drive wheels I2a, I2b and linkage skates I6a, I6b are polarized, in this embodiment, it is essential that the skates I6a, I6b and wheels I2a, I2b be operatively interconnected to enable the clutching means 20a, 20b to function properly.

In order to assist one in the understanding of the operation of the present invention I0, it would be advantageous to consider use in practice. In a preferred embodiment, Figs. I, and 2, the first linkage skate I6a is orientated such that the fore portion 26a faces clockwise and the aft portion 28a faces counter-clockwise. As such, when the first pedal subassembly 90a is pushed, and hence in the drive mode, the first linkage skate I6a begins to move in the aft direction 28a until the skate I6a engages the drive wheel I2a and sprocket 3I thereby rotating the first drive wheel I2a and sprocket 3I in the counterclockwise direction, wherein the sprocket 3I engages the rear sprocket assembly of the rear road wheel via a chain thereby rotating the rear road wheel. In this embodiment, virtually I00% of the force and energy applied to subassembly 90a is harnessed and transferred to the first drive wheel I2a because the cable 94a is constantly tangent to the first drive wheel I2a.

Simultaneously, the second pedal subassembly 90b is in the free-access mode, wherein the second linkage skate I6b is moving in its respective fore direction 26b, and is preferably about I80 degrees out of phase from the first pedal subassembly 32a. This phase control is achieved, inter alia, by incorporating a phase pulley 96a between the first and second drive wheels I2a, I2b. The phase pulley 96a is mounted on to the bicycle frame (See Fig. I). The phase control is further achieved, inter alia, by the third cable 94c which connects the fore portion 26a of the first skate linkage I6a to the fore portion 26b of the second skate linkage I6b, wherein the third cable 94c travels about the periphery of the phase pulley 96a, preferably in a grooved track (not shown). Upon the respective pedal subassemblies 90a, 90b reaching their apogees and perigees, each pedal subassembly 90a, 90b then begins its respective inverse orbit.

Optionally, a second phase pulley 96b may be incorporated in the bicycle drive train I0. One basis for incorporation of the second phase pulley 96b is to further harness the available energy supplied by the peddler/rider (hereafter peddler). For example, the first phase pulley 96a optimizes the typical downstroke/powerstroke of the quadracep muscles, wherein the second phase pulley 96b would both harness and optimize the upstroke primarily of the hamstring muscles. Specifically in a preferred embodiment, the second phase pulley 96b is mounted in the front of the bicycle such that a fourth cable 94d, connecting the two peddle subassemblies 90a, 90b together, would be in the same plane as cables 94a, 94b. More specifically, for example, when peddle subassembly 90a is being acted on by the peddler's quadricep, cable 94a would move vectorily toward the front of the bicycle, while simultaneously, the peddler's hamstrings are acting on peddle subassembly 90b thereby cable 94d would be pulling on peddle subassembly 90a vectorily in the same direction and plane, namely, towards the front of the bicycle.

In order to minimize the effects of inertia in reversing direction, it is preferred that the overall diameter of the phase pulleys 96a, 96b be minimized, while maximizing the inner portion 98 of the pulley 96. For example, each phase pulley 96a, 96b consists, inter alia, of two circular portions, namely an inner circle 98 and an outer ring I00 having a breadth B. The inner circles 98 are affixed to the bicycle frame as shown in Fig. I, whereas between the outer ring I00 and the inner circle 98 are ball bearings; wherein it is preferred that the breadth B be minimized thereby reducing the amount of inertia of the outer ring I00.

Moreover, optionally, a momentum assistance spring I02 may be incorporated with each drive wheel I2a, I2b and/or with each phase pulley 96a, 96b. For example, when the respective pedal subassemblies 90a, 90b approach their respective apogee/perigee combinations, there appears to be hesitance or flat spot in the pedaling cycle experienced by the peddler of the vehicle. As such, a momentum assistance spring I02 may be incorporated and calibrated to assist the peddler and to smooth the transition in direction of the pedal subassemblies 90a, 90b at the apogee/perigee combinations during the pedaling cycle.

Referring generally to FIGS. 3H and 3I, an alternative embodiment includes, inter alia, a drive wheel II2a, II2b that reduces the inertia of the drive wheel II2a, II2b by reducing the amount of mass thereof. For example, in the concept set forth above, the breadth of the outer ring is minimized, in this alternative embodiment, FIGS. 3H and 3I, the amount of periphery provided on the drive wheel II2a, II2b may be or may also be reduced, this can be determined by calculating the number of linear feet “lf” each pedal I92a, I92b travels between its I92a, I92b perigee and apogee wherein at least about the same quantity of linear feet “lf” should be provided for about the periphery of the wheel II2a, II2b. For example, FIG. 3H depicts the perigee position of pedal assembly I92a, I92b. If the pedal assembly I92a, I92b travels twenty-four (24) inches between the apogee and perigee (to the left in the FIG. 3H), the drive wheel II2a, II2b would rotate counterclockwise accordingly, and the angular distance about the periphery of the wheel II2a, II2b should also be at least about 24 inches. It is envisioned that the outer shape of the drive wheel II2a, II2b would be substantially semicircular, having an axis substantially defined by the radius “r” of the semicircle.

Moreover, a torsional spring I98c, I98d may be incorporated about the axis of the drive wheel II2a, II2b so as to restore the drive wheel II2a, II2b to the beginning of its II2a, II2b power stroke (perigee). Thus, because the drive wheel II2a, II2b travels bidirectionally, and because the sprocket wheel I3I travels unidirectionally, the drive wheel II2a, II2b is cooperatively connected to the sprocket wheel I3I via connecting means I30 such as the axle connecting the plurality of drive wheels II2a, II2b. For example, a clutching means I20a, I20b is provided between an inner ring II3a, II3b, affixed to either the axle (the only option for the drive wheel II2b opposite the sprocket wheel I3I) or the sprocket wheel I3I (only an option for the drive wheel II2a on the same side of the drive train II0 as the sprocket wheel I3I), and the outer ring II5a, II5b, wherein the inner ring II3a, II3b travels in phase with the sprocket wheel I3I while the outer ring II5a, II5b travels bidirectionally; wherein the outer ring II5a, II5b may be substantially solid, as in a disc wheel, or substantially spoked, furthermore the outer ring II5a, II5b substantially defines the periphery whereabout the cable I34a, I34b substantially travels. Specifically, one end of the cable I34a, I34b is affixed to the distal end of the drive wheel II2a, II2b; wherein the cable I34a, I34b lays substantially about the periphery of the drive wheel II2a, II2b and operatively connects to the peddle assembly I92a, I92b. When a rider begins pushing on the pedal assembly I92a, I92b in its perigee position, the clutching means I20a, I20b engages beginning the power stroke, and upon obtaining the apogee, the clutching means I20a, I20b would disengage while the torsion spring I98c, I98d restores the pedal assembly I92a, I92b to its perigee via the drive wheel II2a, II2b and cable I34a, I34b.

In a preferred embodiment, the clutching means I20a, I20b comprises a ratcheting means I32a, I32b and an alignment means I60a, I60b; wherein the ratcheting means I32a, I32b comprises a series of teeth having a width I34a, I34b on a first pair of opposing interior walls I36a, I36b on a channel II4a, II4b about the periphery of the inner ring II3a, II3b; wherein the inner periphery II7a, II7b of the outer ring II5a is analogous to the linkage skate I6a, I6b to the extent the inner periphery II7a, II7b includes a plurality of linkage skates formed in series comprising wing means I38 comprising a spring I40, a wing I42, and a recess I48, wherein said wing I42 is rotateably mounted via a pin I50 wherein said spring I40 is mounted between said recess I48 and the distal end of the wing I42, preferably said spring I40 is mounted about the pin I50.

Furthermore, a phase pulley would not be necessary when incorporating a substantially semicircular drive wheel II2a, II2b. In this embodiment, each drive wheel II2a, II2b would function substantially independently from each other II2b, II2a and/or from the sprocket wheel I3I.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. A drive train comprising:
a first and second drive wheel, each wheel having a center defining the axis thereof and for connecting to a bicycle frame, said wheel having a substantially enclosed channel about its periphery for housing a linkage skate, said channel having an opening orientated radially outward from said center and having a series of teeth on a first pair of opposing interior walls;
said linkage skate having a body having connecting means on the fore and aft portion thereof; wherein a clutch means is cooperatively formed by said skate and said channel;
wherein at least one of said drive wheels also has means for connecting to a sprocket wheel;
a phase pulley positioned in between said first and second drive wheels on the bicycle frame; and
a pedal assembly operatively connected to the frame; each pedal operatively connected together via a cable system; said cable system having a first cable connecting the first pedal assembly to the connecting means of a first linkage skate, a second cable connecting the second pedal assembly to the connecting means of a second linkage skate, and a third cable connecting said skates via connecting means;

2. A drive train as in claim I, wherein said clutching means comprises a ratcheting means and an alignment means.

3. A drive train as in claim 2, wherein said ratcheting means comprises a series of teeth having a width on a first pair of opposing interior walls on said channel; cooperatively engaging with a wing means on each side of said body.

4. A drive train as in claim 3, wherein said wing means comprises a spring, a wing rotateably mounted via a pin within a recess in the body having a torsional spring mounted therebetween.

5. A drive train as in claim I, wherein said alignment means includes a translation means.

6. A drive train as in claim 5, wherein said translation means provides a characteristic selected from the group consisting of friction reduction, wear reduction, and alignment assistance.

7. A drive train as in claim I, wherein said alignment means optionally includes a rolling means with a groove for said rolling means to reference.

8. A drive train comprising:
a first and second drive wheel, each wheel having a center defining the axis thereof and for connecting to a bicycle frame, said wheel having a substantially enclosed channel about its periphery for housing a linkage skate, said channel having an opening orientated radially outward from said center;
said channel and linkage skate cooperatively forming a clutching means; wherein said linkage skate comprises a body with connecting means on the fore and aft portion thereof;
wherein at least one of said drive wheels also has means for connecting to a sprocket wheel; and
a pedal assembly operatively connected to the frame; each pedal subassembly operatively connected together via a cable system; wherein said cable system includes a first cable connecting the first pedal subassembly to the connecting means of a first linkage skate, a second cable connecting the second pedal subassembly to the connecting means of a second linkage skate, and a third cable connecting said skates via connecting means.

9. A drive train as in claim 8, wherein said clutching means comprises a ratcheting means and an alignment means.

10. A drive train as in claim 9, wherein said ratcheting means comprises a series of teeth having a width on a first pair of opposing interior walls on said channel; cooperatively engaging with a wing means on each side of the body.

11. A drive train as in claim I0, wherein said wing means comprises a spring, a wing having a proximal and distal end, and a recess in said body, said wing being rotateably mounted to said body via a pin near the proximal end wherein said spring is mounted between said recess and said distal end.

12. A drive train as in claim 8, wherein said alignment means includes a translational means.

13. A drive train as in claim I2, wherein said translational means provides a characteristic selected from the group consisting of friction reduction, and wear reduction.

14. A drive train as in claim 8, wherein said alignment means further includes a rolling means with a groove for said rolling means to reference.

15. A drive train as in claim 8, wherein said drive train further includes a first phase pulley positioned in between said first and second drive wheels on the bicycle frame.

16. A drive train as in claim 8, wherein said cable system includes a first cable connecting the first pedal subassembly to the connecting means of a first linkage skate, a second cable connecting the second pedal subassembly to the connecting means of a second linkage skate, and a third cable connecting said skates via connecting means.

17. A drive train as in claim I5, wherein said drive train further includes a second phase pulley cooperatively connected to the subassemblies via a cable.

18. A drive train as in claim I6, wherein said cable is within about the same plane as said first and second cables.

19. A drive train as in claim I6, wherein said phase pulley comprises an inner circle affixed to the frame, and cooperatively connected to an outer ring having a breadth and means for guiding cable about the periphery of said ring.

20. A drive train as in claim I9, wherein said means include a groove.

21. A drive train as in claim 8, wherein a momentum assistance spring is optionally incorporated with at least one drive wheel.

22. A drive train as in claim I5, wherein a momentum assistance spring is optionally incorporated with said first phase pulley.

24. A drive train comprising:
a plurality of drive wheels, each wheel having a center defining the axis thereof and for connecting to a bicycle frame and having in inner and outer ring; said inner ring having a substantially enclosed channel about its periphery for housing the inner periphery of said outer ring; said channel having an opening orientated radially outward from said center;
said channel and said inner periphery cooperatively forming a clutching means; wherein at least one inner ring has means for connecting to a sprocket wheel; and
a pedal assembly operatively connected to the frame wherein each pedal subassembly is operatively connected a drive wheel.

25. A drive train as in claim 24, wherein at least one inner ring is cooperatively connected to the sprocket wheel via a connecting means.

26. A drive train as in claim 24, wherein said clutching means comprises a ratcheting means and an alignment means.

27. A drive train as in claim 26, wherein said ratcheting means comprises a series of teeth having a width on a first pair of opposing interior walls on said channel.

28. A drive train as in claim 27, wherein said inner periphery of said outer ring comprises a series of wing means having a spring, a wing, and a recess; wherein said wing is rotateably mounted via a pin with said spring mounted between said recess and said wing about said pin; wherein said wing means cooperatively interact with said teeth.

29. A drive train as in claim 24, wherein a momentum assistance spring is incorporated with said drive wheel.

30. A drive train as in claim 24, wherein each drive wheel functions substantially independently from each other.
